(19) United States
(12) Patent Application Publication
(10) Pub. No.: US 2011/0175361 A1
(43) Pub. Date: Jul. 21, 2011

(54) FLOW CONVERTER

(75) Inventors: Gerold Seyfarth, Leipzig (DE); Siegfried Höfgen, Steina (DE); Holger Langlotz, Gotha (DE)

(73) Assignee: SIGNO-ERFINDERVEREIN SACHSEN E.V., LEIPZIG (DE)

(21) Appl. No.: 13/003,455

(22) PCT Filed: Jul. 2, 2009
(86) PCT No.: PCT/EP2009/004803

§ 371 Date: Apr. 6, 2011

(30) Foreign Application Priority Data
Jul. 10, 2008 (DE) 10 2008 032 411.6

(51) Int. Cl. F03B 13/10

(52) U.S. Cl. 290/54

(57) ABSTRACT

A device converts mechanical energy to other forms of energy, preferably to electrical energy. The device referred to as a flow converter has been configured such that a rotating turbine cone set into motion by a flow medium has spiral-shaped impeller blades disposed on the circumference thereof and is supported relative to a fixed housing by a main bearing. The device is sealed by slip ring seals, axial shaft end sealing rings and radial shaft end sealing rings such that units for efficiently converting rotary speed and converting energy can be located in a hollow space created thereby and can be effectively protected against penetration of the flow medium. Flow material can be discharged by the structure of the flow converter, and large power levels can be transferred.

The invention relates to a device for converting mechanical energy to other forms of energy, preferably to electrical energy. The device referred to as a Flow Converter has been configured so that it can be used for electric energy generation in a great number of flow media through its compact design including an integrated generator and an equally integrated gear unit, if necessary, and a bearing system which is also integrated. A rotary cone with spiral-shaped impeller blades arranged on its circumference which can be rotated against a housing on the conical head by means of a bearing system, incorporates the devices for rotary speed conversion, for energy conversion and to seal it off against the flow medium.

Turbines of the most diverse sizes and designs, which are used to convert wind and water power to electric energy, are well known.

These include a screw described in DE 297 21 671 U1 which extracts energy from water flow or moving air and which is characterized by 2 to 5 single-winded screw blades fixed to a hollow cone which can be flushed with the flow medium, which has a screw diameter equal to the screw length and with a conical head half the diameter of the screw.

Furthermore, there is a turbine in U.S. Pat. No. 4,722,665 which includes a hollow cone incorporating a gear unit and several generators and where the electricity cable is led outside via a hollow shaft which is arranged in flow direction on the cone tip and which bears the entire turbine structure.

Both U.S. Pat. No. 1,191,950 and FR 557 189 describe cone turbines arranged in double and held in bearings outside the cone-shaped turbine body used for water power utilization.

The U.S. Pat. No. 188,020 and FR 827 487 describe cone turbines arranged on one side and held in bearings outside the cone-shaped turbine body used for wind power utilization.

From WO 95 24562 we know an axial flow turbine which consists of a rotary unit and a fixed unit used as a inlet guide unit, this turbine being configured inside a piping system, enabling a constant static pressure in the turbine by means of the geometries of both body and blade.

As described in DE 20 2006 001 171, the state of the art also includes an electric water power generator with low rotational speed, which is shaped like a cylindrical roll supported by bearings on both ends, the circumference of which is provided with paddles to extract water power.

Though the turbine described in DE 297 21 671 U1 offers the chance to convert kinetic energy of both water and wind to a rotary motion by using its external design, the transmission of rotary motions outside the turbine may lead to blocking and damage in the overdrive or any other driving elements, especially when the flow media contain floating material.

In the turbine pursuant to U.S. Pat. No. 4,722,665 the transmission gearing and the energy conversion unit are incorporated in the turbine cone which offers some advantage, as the hollow shaft of the bearing is located counter-flow-wise on the pointed end of the cone, but there is the higher risk of floating material accumulating in front of the turbine and in the turbine blades. If you use a smaller diameter shaft which would not impeach the device receiving the fluid flow, larger rotary speeds cannot be transferred. Since the shaft output has been arranged in flow direction, the seals to be inserted would also have to resist the banking-up pressure, which would require highly expensive technology.

The turbines from U.S. Pat. No. 1,191,950 and FR 557 189 also include driving and bearing elements which are located outside the cone-shaped basic turbine body. This again bears the risk of floating material accumulating and driving elements being damaged. The embodiments with external bearings and drives described in the U.S. Pat. No. 188,020 and FR 827 487 are only appropriate for wind power utilization for the above reasons.

A turbine as in WO 95 24562 which would be arranged inside a pipe on a bearing system on both external sides of the basic body can also only be used in clean flow media.

The disadvantage of damage from floating material also applies to the electric water power generator according to DE 20 2006 001 171 with a generator shaft which runs on bearings on both sides if its axle is directly located in the flow medium.

Up to now, these types of turbines, as well as the well-known high-capacity turbines, had to be provided with protective guards to prevent damage from floating material.

This intention is based on the purpose of developing a turbine which, by its compact design and without substantial obstacles to the flow, can be used in all types of flow media for efficient energy conversion without having to incorporate additional devices as a defense against floating material.

The requirements of the invention are met by supporting the turbine cone on the conical head wall so that it is able to rotate against a stationary housing which has a diameter not exceeding that of the conical head and which is sealed against the housing, with the chance to configure the internal units either in the cone area or in the turbine housing area for speed and power conversion.

It has been proven as extremely advantageous if you configure the unit for converting mechanical to electrical power on the one hand with a magnetic ring which is fixed to the turbine cone and rotates along with it and on the other with a stationary coil core in the turbine cone which is fixed to the housing.

It is advantageous to use planetary gears in the hollow space of turbine cone and housing if you use units for rotary speed conversion.

In a further embodiment of the invention it is extremely advantageous to use standardized subassemblies for the units for rotary speed and energy conversion and to locate them in the hollow space between turbine cone and housing. When doing so it is extremely advantageous to configure the generator as a water-cooled IP68 protection class synchronous generator.

In order to reduce inspection intervals it is an advantage to fill the gear wheels with a long-life lubricant if you use a standard planetary gear unit.

In accordance with claim 1 of the invention, it is an advantage if the turbine cone runs on bearings on the conical head wall enabling it to rotate against a fixed housing which has a diameter not exceeding that of the conical head, the cone being sealed against the housing.

It is a particular advantage if several shaft seals are arranged between the stationary housing and the rotating turbine cone, which have both radial and axial effects. Flat seals which are used between the structural components which are fixed in relation to each other are extremely advantageous. These seals will prevent the flow media penetrating into the hollow space, thus protecting the internal units

Pursuant to another embodiment of the invention, it is extremely advantageous to manufacture the material of both turbine and housing from corrosion-resistant material.

It is a particular advantage if the turbine cone is produced from plastic material in a particulate process offering the chance to already encapsulate the energy converter elements at this early stage.

In accordance with another embodiment of the invention, where the device is used as a flow converter in clean flow media, it is extremely advantageous if the turbine cone, together with its attached blades and the housing are fixed in relation to each other so that the turbine cone with blades can be used as an inlet guide vane, and to incorporate at the same time a rotary impeller wheel between turbine cone and housing.

Here, it is a particular advantage if the turbine impeller wheel has a core diameter equal to but not exceeding the conical head of the turbine cone, and if the blades attached to it are arranged in the opposite, ascending direction to the inlet guide wheel blades.

In another embodiment of the invention, it is extremely advantageous to design the flow converter housing aerodynamically and so that it rotates around its vertical axis, which would allow the preferable utilization of the flow converter as a wind power plant.

The invention is described in more details below illustrating it by some examples of embodiments and the corresponding reference numbers in the figures.

The figures represent the following:

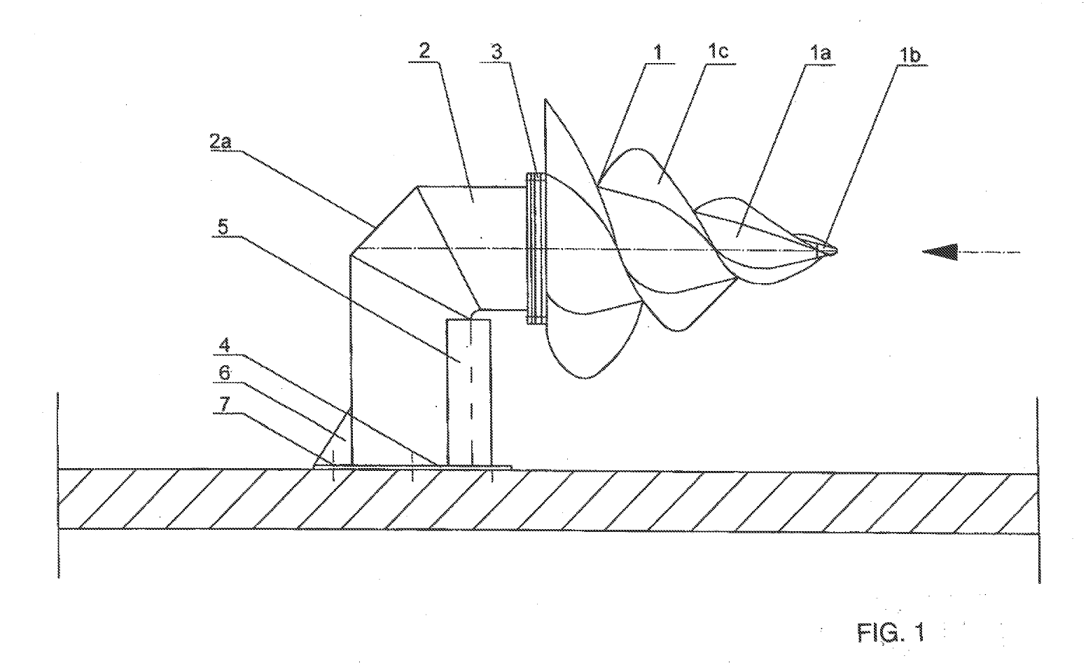

FIG. 1. Flow converter, side view including cone and housing unit

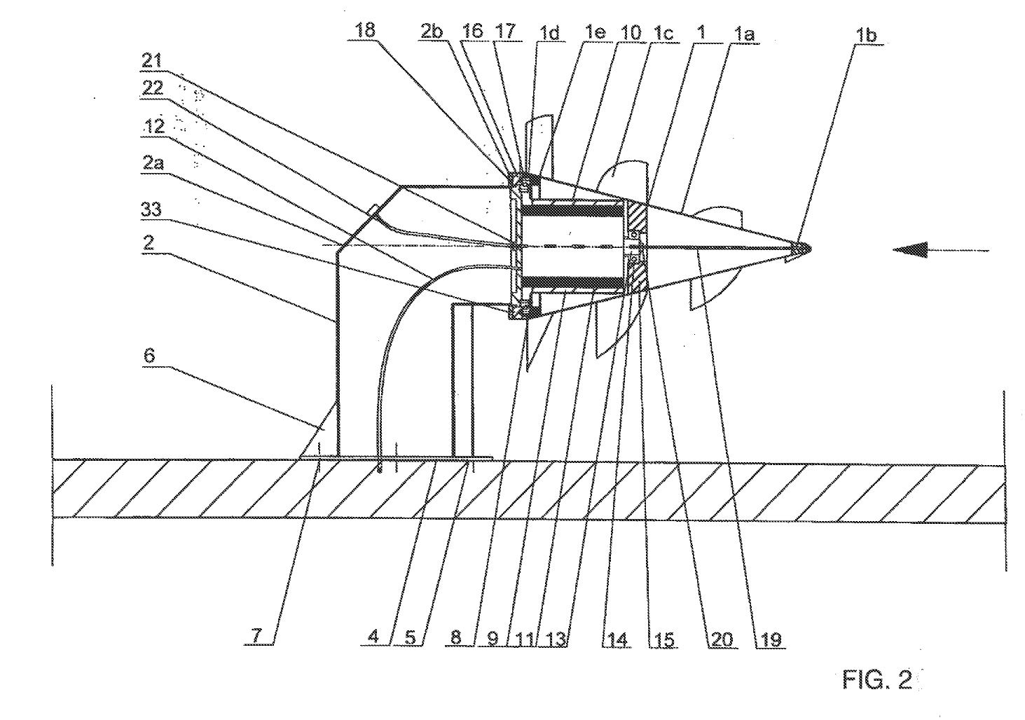

FIG. 2. Flow converter, side section with integrated unit for speed conversion and energy conversion in the cone, including the inserted magnet ring

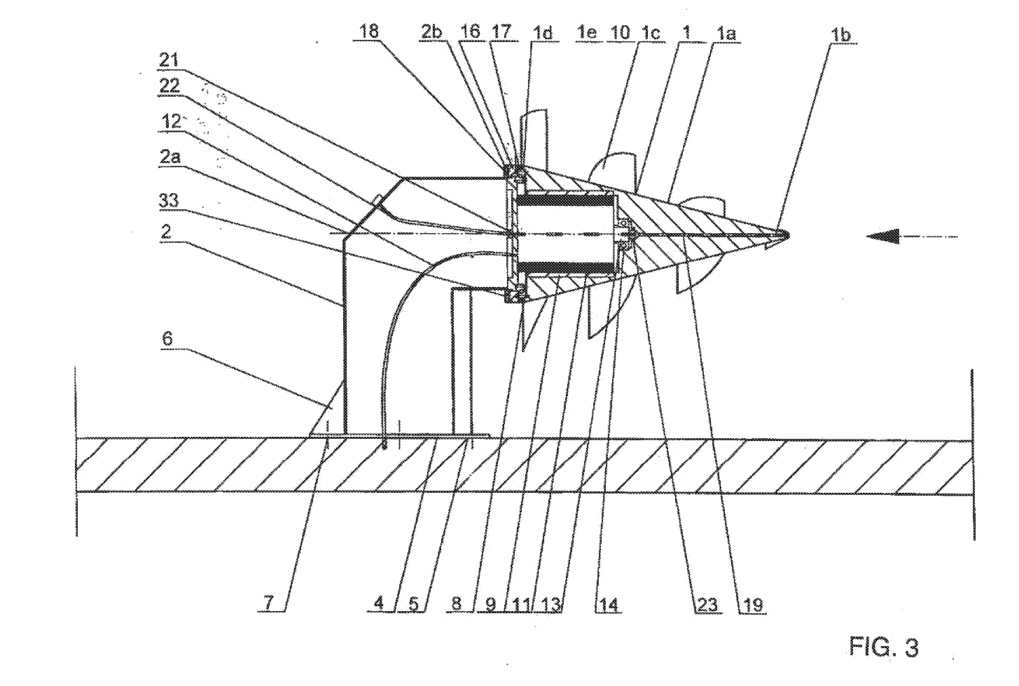

FIG. 3. Flow converter, side section with integrated unit for speed conversion and energy conversion in the cone, including the encapsulated magnet ring

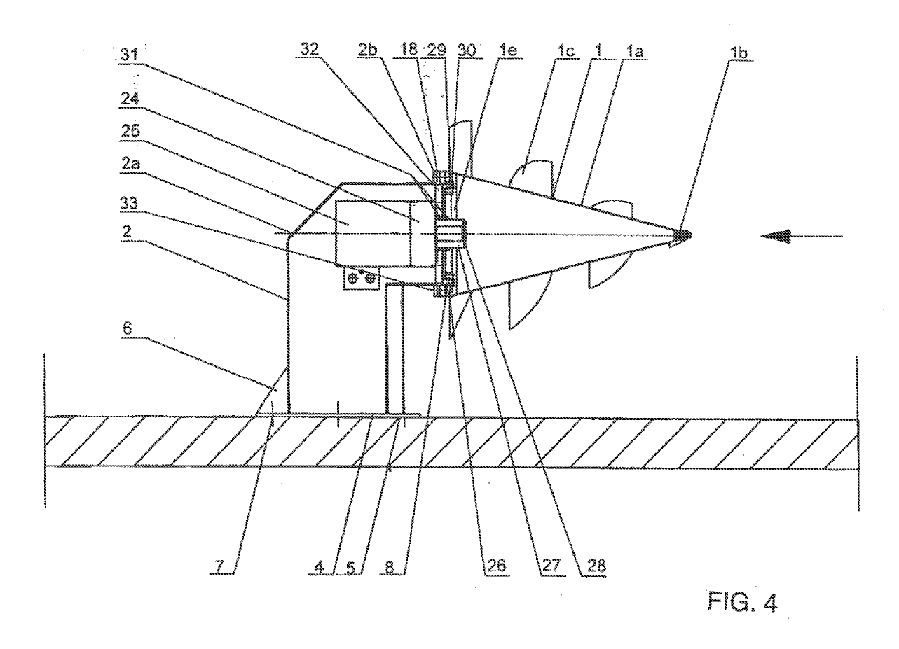

FIG. 4. Flow converter, side section with integrated unit for speed conversion and energy conversion as standard subassemblies in the housing

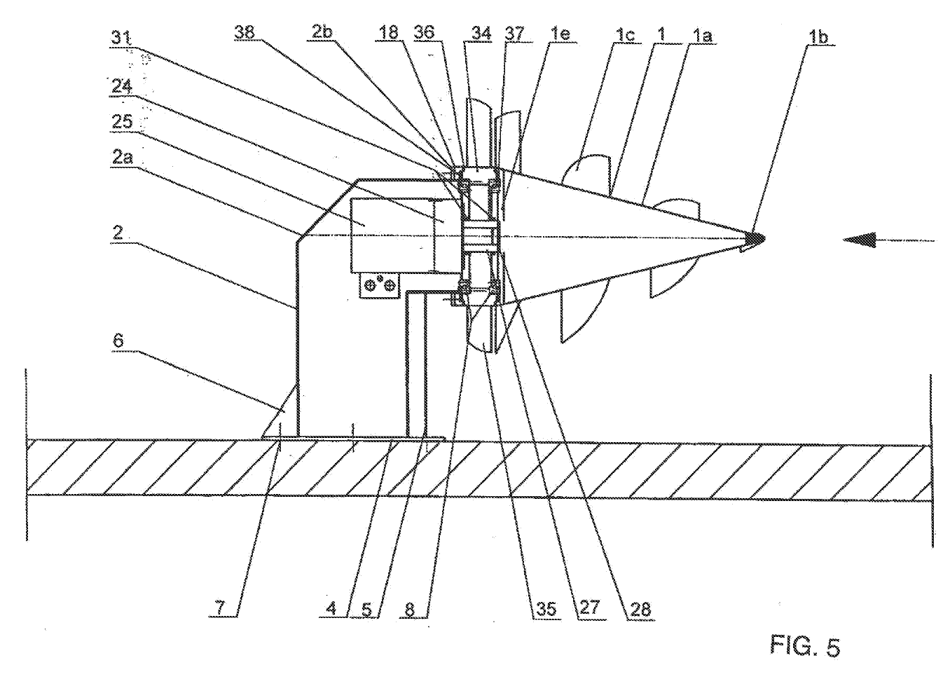

FIG. 5 Flow converter, side view including the cone inlet guide wheel, turbine wheel and housing

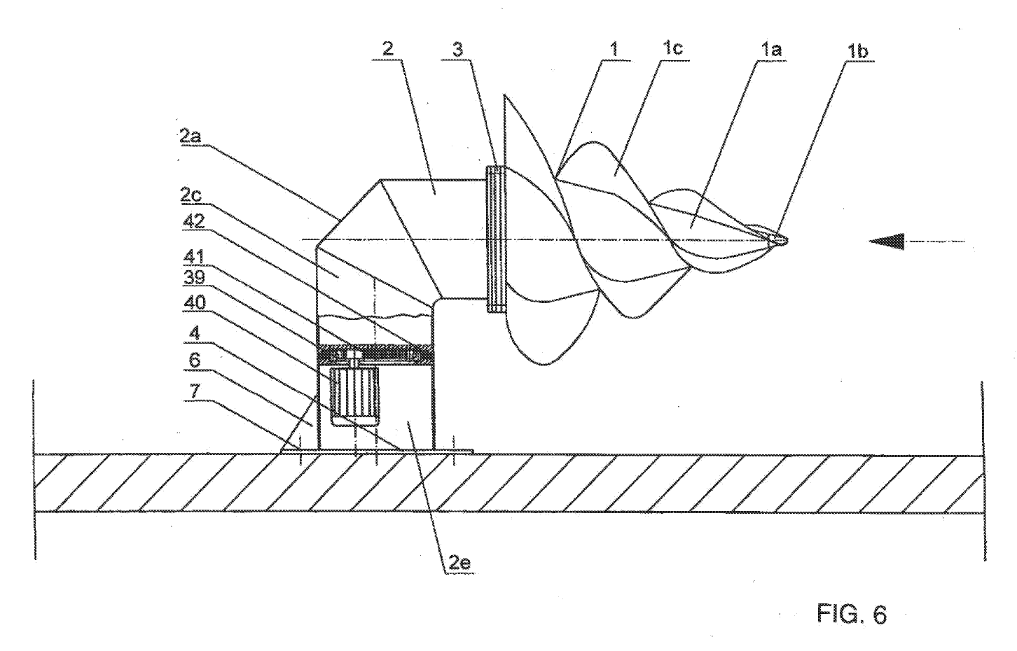

FIG. 6 Flow converter, side view including the rotary housing axle

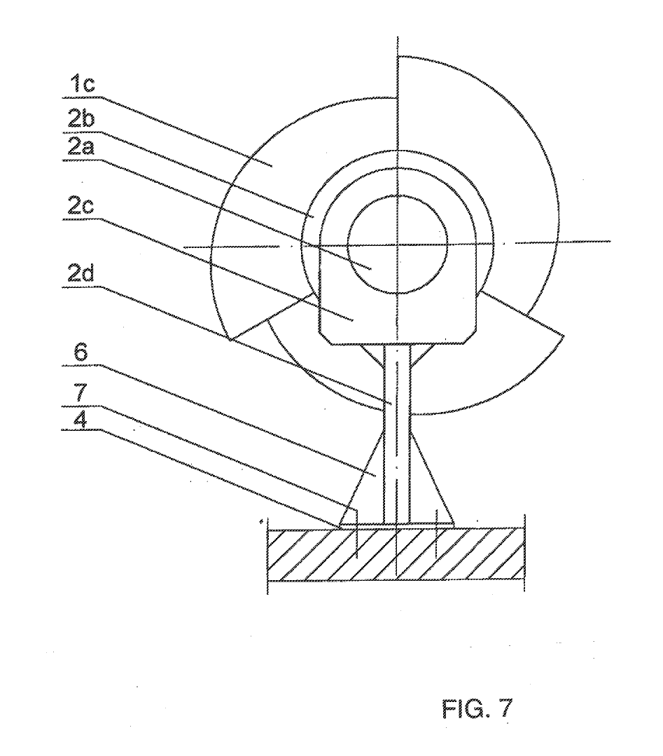

FIG. 7 Flow converter, rear view including narrow housing base

In a first embodiment, represented in FIGS. 1 and 2, a flow converter has been designed so that a turbine cone 1, consisting of a cone envelope 1a and a cone tip 1b, on which there are arranged, in a uniformly spaced, offset arrangement, several, preferably three, spiral-shaped screw twists tapered off towards the cone tip 1b, this turbine cone 1 rotating on bearings against a fixed housing 2. There are several connecting flanges 3 arranged between turbine cone 1, which is preferably made of steel, and housing 2 which is also preferably made of steel. On the bottom section of housing 2 there is a base plate 4 which has been fixed, preferably by waterproof welding, to housing 2 in order to fix the housing to the substrate. The vertical base of turbine housing 2 is provided with a flow wedge 5, which is preferably made of steel plate, angle-shaped and fixed to housing 2, preferably by welding it to housing 2, the sharp angle oriented against the direction in which the medium flow is received by the device.

To stabilize housing 2 in the base area, several sheet steel corner plates 6 have been arranged, preferably by welding them to both of the components, between housing 2 and base plate 4. Housing 2 may be fixed to the flow converter using fastening elements 7 against the force of the flow medium. Inside the hollow space formed by the interior of turbine cone 1 and housing 2, which is sealed off against the flow medium, there are the following elements: a main bearing 8 on which turbine cone 1 runs and rotates; a unit for energy conversion arranged inside the cone envelope 1a, consisting of a magnet ring 9 which is located inside a magneto bell 10 and fixed to turbine cone 1; a coil core 11 which is fixed to turbine housing 2; and an electric cable 12 which is led outside starting from coil core 11 and passing through the sealed housing 2. On the end of coil core 11 which is directed to cone tip 1b, there is a bearing journal 12 which is fixed to the coil core. There is a counter-bearing 14 seated on the journal, in this example preferably a maintenance-free anti-friction bearing. An axially-synchronous run from magnetic rotor 9 to coil stator 11 is ensured by both main bearing 8 and counter-bearing 14.

Anti-friction bearing 14 is fixed with its external race in bearing housing 15, which is fixed to cone envelope 1a, in a centerline position relating to the rotating axis; the drilled hole as the seat of the rolling bearing having been drilled into the bearing housing 15 synchronous to the axis of the external centerline seat 1d of turbine cone 1 in which the main bearing 8 is located.

To seal turbine cone 1 off against the housing 2 in relation to which the cone rotates, seal packs 17 are provided in the built-in bell 16. These seals are preferably designed as radial and axial shaft end sealing rings. Flat seals 18 have been inserted between the races of main bearing 8 and the magneto bell 10 on the one hand and the bearing race of main bearing 8 and the housing flange 2b on the other. The shaft end seals 17 and flat seals 18 protect the unit for energy conversion from flow media penetrating into the hollow space.

To cool the generator which is located inside, a central feed line 19 is aligned to the axis, the cooling agent, which is preferably identical to the flow medium, flowing, starting from the cone tip 1b to the feed line 19, passing on its way a rotating hose coupling 20 on bearing journal 13, thus absorbing the heat generated in the coil core, and then flowing into the discharge hose 22 by means of a fixed hose coupling 21, the discharge hose being led outside via the housing cover 2b. To protect the surface from damage and corrosion, all surface areas of turbine cone 1 and of housing 2 having contact with the flow medium are provided with special coating. You may alternatively choose to make the embodiment 1 from noncorroding steel.

In a second example which is displayed in FIG. 3 the turbine cone 1 is completely made of plastic material in a particulate process, during which the magnetic ring 9, the counter-bearing 14, and the elements fixing the turbine cone unit to the main bearing 8 are already encapsulated. You can thus save some expenses during the manufacturing of the seats of the bearings and even avoid another flat seal 18 between main bearing 8 and magnetic rotor 9. The rotating turbine cone 1 and the stationary bearing journal 13 are sealed off against each other by means of a slip ring seal 23.

A third example of an embodiment, represented in FIG. 4, makes use of a flow converter whose housing 2 is provided with both a unit for rotary speed conversion 24 and a unit for energy conversion 25, which are mechanically coupled to one other. Each of units 24 and 25 is configured from standard subassemblies. The rotary speed is extracted by the gear unit 24 which is rigidly fixed to the housing 2 by means of a centering cover 26, the gear being designed in this example as a compact, planetary gearing with long-life oil fill thus requiring but low maintenance, through a driving bush 27 which is fixed, preferably by welding, to the conical head 1e of turbine cone 1, the end of the driving bush being sealed by a cover 28 which is waterproof welded to bush 27.

Generator 25, which is designed as a water-cooled synchronous generator in this example, has been connected to gear unit 24 so that the rotary speed supplied by the flow generator is converted in gear unit 24 and transferred to generator 25. The rotary speed conversion achieves a generator speed which is close to the synchronous speed, thus increasing the efficiency of the turbine. You can use this embodiment even without a gear unit, if the generator design is appropriate, and this design is also claimed. The water cooling function of generator 25 does not depend on the flow medium. Therefore, you can provide a temperature control system in generator 25 which avoids any condensation water. The centering cover 26 is provided with a slip ring seal 29 which, in combination with axial shaft end sealing ring 30 and the radial shaft end sealing rings 31 located on the driving bush 27, will protect gear unit 24 and generator 25 from flow medium penetrating into the hollow space. The entire turbine cone unit is inserted into housing 2 long with the centering cover 26 and the gear unit 24 and generator 25 mounted on it, centered in relation to centering flange 32, and fixed with the bolts 33.

You may alternatively use other generators, such as asynchronous generators and linear generators, both with or without gear units, for this example of an embodiment.

In a fourth example of an embodiment referred to in FIG. 5, the turbine cone 1 is rigidly fixed to housing 2. Behind turbine cone 1, which is used as an inlet guide wheel here, there is a turbine impeller 34 which converts the flow to a rotary motion. Turbine impeller 34 is provided with several blades 35, which are arranged in the opposite way and ascending to those arranged on the turbine cone, their height level corresponding to the maximum height of those arranged on the cone. The core diameter of impeller 34 never exceeds the conical head 1e however. The rotary motion of the turbine impeller is transferred via a bearing system consisting of two main bearings 8, to the interior hollow space of housing 2 and turbine cone 1 where the units for rotary speed and energy conversion are located. Labyrinth seals 36, radial shaft end sealing rings 37, and slip ring seals 38 are used to seal off the rotating impeller 34 and fixed housing 2 and turbine cone 1.

In a fifth example of an embodiment referred to in FIG. 6, the flow converter is able to rotate around the vertical housing axle, for which the housing 2 is designed as a cylinder. A rim bearing 39 is arranged between the upper housing section 2c and the lower housing section 2d. The inner race of rim bearing 39 is designed as an internal ring gear, into which a pinion 41 driven by a motor 40 engages, thus setting the entire upper turbine section into motion in relation to the stationary lower housing section 2d. If the turbine is used for wind power extraction, the cone point 1b can thus always be directed against the wind flow to be received. If you use the turbine for fluid media as in this example, this point of rotation should equally be provided with a device for sealing the upper housing section 2c off against the lower housing section 2d using the seal pack 42 which comprises several individual seals.

In a sixth example represented to in FIG. 7, the units for rotary speed and energy conversion are arranged in the hollow space of turbine cone 1 and upper housing section 2c and protected against the flow medium by sealing. The lower housing section 2d has been tapered off here transversally to the axis in the direction of the base plate 4 braced with sheet steel corner plates 6. You can thus dispense with the flow wedge 5 in this variant of embodiment.

Any combinations between the different examples of embodiments are possible and are therefore also claimed.

### LIST OF REFERENCE NUMBERS

1 Turbine cone
1a Cone envelope
1b Cone tip
1c Screw jack
1d External centering seat
1e Cone head
2 Housing, turbine housing
2a Installation and inspection flap
2b Housing flange
2c Upper housing section
2d Lower housing section
3 Connecting flange
4. Base plate
5. Flow wedge
6 sheet steel corner plate
7. Connecting element, bolt
8. Main bearing
9. Magnetic ring, magnetic rotor
10 Magneto bell
11 Coil core, coil stator
12 Electric cable, cable
13 Bearing journal
14 Counter-bearing, anti-friction bearing
15 Bearing casing
16 Built-in bell
17 Seal pack, shaft end sealing ring
18 Flat seal
19 Central feed line for water cooling, feed conduit
20 Rotary hose coupling
21 Stationary hose coupling
22 Discharge hose
23 Slip ring seal
24 Rotary speed conversion unit, gear unit
24 Energy conversion unit, generator
26 Centering cover
27 Driving bush
28 Sealing cover
29 Slip ring seal
30 Shaft end sealing ring with axial effect, axial shaft end sealing ring
31 Shaft end sealing ring with radial effect, radial shaft end sealing ring
32 Centering flange
33 Bolt
34 Turbine impeller, impeller
35 Blades, turbine blades
36 Labyrinth seal
37 Turbine impeller radial shaft end sealing ring
38 Turbine impeller slip ring seal
39 Rim bearing
40 Motor, azimuth motor
41 Pinion
42 Rim bearing seal pack

1-20. (canceled)

21. A flow converter, comprising:
a rotating turbine cone set into motion by a flow medium and having a circumference, spiral-shaped impeller blades disposed on said circumference, a conical head and a conical head side;
a unit for converting rotary speed;
a unit for converting energy; and
a stationary housing supporting said rotating turbine cone and defining a hollow space therein, said rotating turbine cone can be rotated on said conical head side against said stationary housing, said stationary housing having a diameter not exceeding that of said conical head and being sealed off, such that said unit for converting rotary speed and said unit for converting energy disposed in said hollow space can be effectively protected against penetration of the flow medium, floating material can be discharged by a structure of the flow converter, and large power levels can be transferred.

22. The flow converter according to claim 21, wherein said unit for energy conversion unit has a magnetic rotor fixed to said rotating turbine cone and thus driven, and a coil core fixed to said stationary housing.

23. The flow converter according to claim 21, further comprising a magneto bell having a circumference and several magnets disposed at said circumference of said magneto bell, said several magnets in their combination form a rotating magnetic ring.

24. The flow converter according to claim 23,
wherein said stationary housing has a housing flange;
further comprising a built-in bell;
further comprising shaft end sealing rings for sealing off said rotating turbine cone against said stationary housing and disposed in said built-in bell having a diameter not exceeding a diameter of said cone head;
further comprising a centering cover; and
further comprising flat seals disposed between said housing flange, said magneto bell, and said centering cover.

25. The flow converter according to claim 21,
wherein said stationary housing has a lower section;
further comprising a base plate in said lower section; and
further comprising a flow wedge directed against a flow to receive, said base plate and said flow wedge are fixed to said stationary housing.

26. The flow converter according to claim 21, wherein said rotating turbine cone and said stationary housing are made of steel, and have subassemblies which cannot be moved against each other and are welded together.

27. The flow converter according to claim 21, wherein all surface areas having contact with the flow medium have anticorrosion protection.

28. The flow converter according to claim 27, wherein all said surface areas having contact with the flow medium are made of a non-corroding steel.

29. The flow converter according to claim 23, wherein said rotating turbine cone is made from a plastic material which is resistant against the flow medium, and in a particulate process during which energy converting elements, including said rotating magnetic ring, have been encapsulated.

30. The flow converter according claim 22,
wherein said unit for energy conversion is a generator; and
further comprising a central cooling system for cooling said generator, said central cooling system having a rotary hose coupling, a stationary hose coupling, a central feed line and a discharge hose, said central feed line and said discharge hose are connected to said coil core via said rotary hose coupling and said stationary hose coupling.

31. The flow converter according to claim 21, wherein said unit for rotary speed conversion and said unit for energy conversion have standardized subassemblies, said unit for rotary speed conversion is a planetary gear requiring but minimum maintenance, and said unit for energy conversion is a generator configured as a water-cooled synchronous generator.

32. The flow converter according to claim 21, wherein said unit for energy conversion is an asynchronous motor.

33. The flow converter according to claim 21, wherein said unit for energy conversion is a linear generator disposed in an annular way.

34. The flow converter in accordance with claim 21, wherein stationary housing is a cylindrical housing subdivided into a stationary lower housing section and a pivoting upper housing section.

35. The flow converter according to claim 34, further comprising a rim bearing having an internal ring gear disposed between said stationary lower housing section and said pivoting upper housing section, said rim bearing having an external race rigidly fixed to said stationary lower housing section and an inner race fixed to said pivoting upper housing section.

36. The flow converter according to claim 35, further comprising:
a motor; and
a pinion driven by said motor and engaging into said rim bearing.

37. The flow converter according to claim 34, further comprising a seal pack disposed between said stationary lower housing section and said pivoting upper housing section and prevents penetration of the flow medium into said stationary housing.

38. The flow converter according to claim 21,
further comprising a turbine impeller;
wherein said rotating turbine cone and said stationary housing are fixed in relation to another and have said turbine impeller between them; and
wherein said turbine impeller has a core diameter not exceeding that of said cone head and has several blades disposed in an opposite way of those disposed on said rotating turbine cone and ascending, their radial length not exceeding a maximum diameter of said rotating turbine cone.

39. The flow converter according to claim 38, further comprising:
radial shaft end sealing rings;
said slip ring seals; and
labyrinth seals, a sealing of said turbine impeller against said stationary housing and said rotating turbine cone is achieved using said labyrinth seals, said radial shaft end sealing rings, and said slip ring seals.

40. The flow converter according to claim 34,
further comprising a base plate; and
wherein said stationary lower housing section tapers off in a vertical axis in relation to said pivoting upper housing section and said base plate.
